(19) United States
(12) Patent Application Publication
(10) Pub. No.: US 2026/0311941 A1
(43) Pub. Date: Oct. 8, 2026

(54) KEY ASSEMBLY WITH SWITCHABLE SOUND AND SILENT STATES

(71) Applicant: GUANGDONG RUIXUN ELECTRONIC TECHNOLOGY CO., LTD., Guangdong (CN)

(72) Inventors: Mingyong TANG, Guangdong (CN); Guangnan ZHU, Guangdong (CN); Jie XIANG, Guangdong (CN); Aihua CHEN, Guangdong (CN); Jianping LI, Guangdong (CN)

(21) Appl. No.: 18/858,770

(22) PCT Filed: Oct. 31, 2023
(86) PCT No.: PCT/CN2023/128506

§ 371 Date: Apr. 8, 2026

(30) Foreign Application Priority Data
Oct. 13, 2023 (CN) 202311325094.5

(51) Int. Cl. H01H 13/14; H01H 13/20

(52) U.S. Cl. CPC H01H 13/14; H01H 13/20; H01H 2215/03

(57) ABSTRACT

The present invention discloses a key assembly with switchable sound and silent states: a swing arm is pivotally connected to a key shaft, which further has a power-storing member for cooperating with the swing arm to strike the key shaft and make a sound; By adjusting the position of the electric control swing rod of the electric switching unit, the present application changes the linkage relationship between the limit structure of the swing arm and the electric control swing rod of the electric switching unit to change the sound state of the key, thereby improving the flexibility and usability of devices, providing users with more usage scenarios, and meeting diverse needs of the users.

### TECHNICAL FIELD

The present invention pertains to the field of keys, and specifically relates to a key assembly with switchable sound and silent states.

### BACKGROUND OF THE INVENTION

A key is the most common interactive element in various electronic devices, and serves to receive user input and trigger a corresponding operation. However, in terms of the press sound, the existing keys often fail to meet diverse needs of users at the same time. For example, some keys may have good tactile feedback, but lack audio response; some keys may have sound effects, but in environments where silence is required, will affect other people and need to be changed for a keyboard in use.

Therefore, for persons skilled in the art, it is a problem crying for solution to invent a key with a function that the sound is adjustable, which can improve the user experience and device interactivity effectively.

### BRIEF SUMMARY OF THE INVENTION

In light of the above problem, the present invention aims to provide a key assembly with an artful structure, which can switch between sound and silent states of the key through an electric control switching unit.

To achieve the technical objective, the present invention has a solution as follows: a key assembly with switchable sound and silent states, comprising a key for cooperating with an electrical component on a baseplate to output a signal, wherein: the key comprises a key base that is assembled on the baseplate and a key shaft that can move up and down in the key base, the key shaft has a reset member, and a swing arm is pivotally connected to the key shaft, which further has an power-storing member for cooperating with the swing arm to strike the key shaft and make a sound; the key assembly further comprises an electric switching unit, which extends toward a bottom portion of the swing arm to form an electric control swing rod, and a limit structure is arranged at the bottom portion of the swing arm; when the electric control swing rod swings to a position where it can come into contact with the limit structure, the electric control swing rod and the power-storing member cooperate with the swing arm to make a keystroke sound when the key shaft is pressed; when the electric control swing arm swings to a position where it cannot come into contact with the limit structure, the swing arm cannot store power to make a sound, leaving a silent state when the key shaft is pressed.

As a preferred option, the power-storing member comprises a power-storing spring and an inclined table that is configured on the key shaft; the swing arm has a middle portion as a pivot portion and an upper portion as a striking portion, the pivot portion has one side that extends to form an abutting table, and the power-storing spring has one end that abuts against the abutting table and the other end that is sleeved on a positioning convex column configured on the key shaft; when the limit structure at the bottom portion of the swing arm descends along with the pression on the key shaft and comes into contact with the electric control swing rod, it is limited and stopped, and further squeezes the power-storing spring to store power, and the key shaft continues to descend, which makes the inclined table push the limit structure away from the electric control swing rod, and further causes the striking portion to swing rapidly and strike the key shaft under the tension of the power-storing spring, thereby making a keystroke sound.

As a preferred option, the limit structure at the bottom portion of the swing arm is a structure that extends downward from the abutting table.

As a preferred option, a cavity slot is configured on an inner side of a side wall of the key shaft, both the swing arm and the power-storing member are arranged in the cavity slot, the cavity slot has a middle portion that is configured as a pivot cavity, the pivot connection between the pivot portion of the swing arm and the key shaft is present in the pivot cavity, and both the inclined table and the positioning convex column are arranged in the pivot cavity.

As a preferred option, the electric switching unit comprises a housing that consists of an electric control upper cover and an electric control base, as well as a magnet and a magnetic conductive plate, the magnetic conductive plate has one end, on which an electromagnetic coil is sleeved, the electric control swing rod is mounted in the magnet, and the electromagnetic coil drives the magnet to rotate, thereby making the electric control swing rod rotate together;
the electric control base has two ends that are provided with two pins, and two terminals are arranged on both ends of the electromagnetic coil and electrically connected to the two pins, respectively.

As a preferred option, a guide column is arranged in the electric control base, a hollow connecting column is configured on the electric control swing rod, and the connecting column is sleeved outside the guide column and inserted into a through hole of the magnet.

As a preferred option, a transparent light guide column is arranged on the baseplate, an LED module is arranged on a bottom portion of the transparent light guide column, and the reset member is a reset spring, which is sleeved on the transparent light guide column.

As a preferred option, an X-shaped balance frame is arranged between the key shaft and the key base, the balance frame is mounted between the key shaft and the key base, and on one end, the balance frame is provided with an inductive portion that can change electrical signals of the electrical component.

As a preferred option, the inductive portion is a grating member, the electrical component is a light pair transistor assembly that consists of a light-emitting component and a light-receiving component, and the light pair transistor assembly is arranged at a position adjacent to a grating to form an optical path, the grating member gradually changes the optical path between the light-emitting component and the light-receiving component along with the descent of the balance frame when the key shaft is pressed, thereby gradually changing luminous flux received by the light-receiving component and forming an optical variable signal.

As a preferred option, the inductive portion is a magnetic member, the electrical component is a Hall sensor, and the magnetic member gradually changes magnetic flux received by the Hall sensor along with the descent of the balance frame when the key shaft is pressed, thereby gradually changing the magnetic flux received by the Hall sensor and forming an electromagnetic signal.

The present invention has beneficial effects as follows: by adjusting the position of the electric control swing rod of the electric switching unit, the present application changes the linkage relationship between the limit structure of the swing arm and the electric control swing rod of the electric switching unit to change the sound state of the key, thereby improving the flexibility and usability of devices, providing users with more usage scenarios, and meeting diverse needs of the users.

### BRIEF DESCRIPTION OF THE DRAWINGS

FIG. 1 is a structure diagram of the present invention;

FIG. 2 is an exploded view of the present invention;

FIG. 3 is a top view of the key shaft in the present invention;

FIG. 4 is an enlarged view of the pivot cavity in the present invention;

FIG. 5 is a structure diagram of the swing arm in the present invention;

FIG. 6 is a structure diagram of the combination of the key shaft and the swing arm in the present invention;

FIG. 7 is a structure diagram of the electric switching unit in the present invention;

FIG. 8 is a structure diagram of the balance frame in the present invention;

FIG. 9 is an enlarged view of the inductive portion and the electrical component in the present invention;

FIG. 10 is a diagram of the positional relationship between the swing arm and the electric switching unit in the silent state in the present invention;

FIG. 11 is a diagram of the positional relationship between the swing arm and the electric switching unit in the sound state in the present invention;

FIG. 12 is a structure diagram of the key shaft in the reset state and the swing arm in the present invention;

FIG. 13 is a structure diagram of the key shaft in the pressed state and the swing arm in the present invention;

FIG. 14 is an exploded view of the electric switching unit in the present invention;

FIG. 15 is a structure diagram of the electromagnetic coil and the pins in the present invention;

FIG. 16 is a structure diagram of the electromagnetic coil, the magnet, and the magnetic conductive plate in the present invention.

In the drawings: 1. baseplate; 11. transparent light guide column; 12. LED module; 2. key base; 3. key shaft; 31. cavity slot; 311. positioning convex column; 312. inclined table; 313. pivot cavity; 32. side wall; 4. reset member; 5. swing arm; 51. striking portion; 52. abutting table; 521. limit structure; 53. pivot portion; 6. power-storing spring; 7. electric switching unit; 71. electric control swing rod; 711. guide column; 72. electric control upper cover; 73. electric control base; 74. magnetic conductive plate; 75. electromagnetic coil; 76. magnet; 77. connecting column; 78. pin; 79. terminal; 8. balance frame; 81. inductive portion; 9. electrical component.

### DETAILED DESCRIPTION OF THE INVENTION

In combination with the drawings and specific embodiments, the present invention will be further described below in detail. To describe the technical solution in a clear and complete manner, the following embodiments are selected for illustration; the following embodiments are some of embodiments of the present invention; other embodiments that are obtained based on the present application without creative labor fall within the scope of protection of the present invention.

In the following embodiments, it should be noted that orientations or positional relationships indicated by the terms such as “up”, “down”, “left”, “right”, “inside”, “outside”, and “top/bottom” are based on the orientations or positional relationships shown in the drawings, for the mere purpose of facilitating a clear description of these embodiment, rather than indicating or implying that the device or component referred to must have a specific orientation; therefore, the terms cannot be understood as limitations upon the present application. Furthermore, the terms “first” and “second” in the embodiments are only used for the purpose of distinguishing the description, and do not indicate or imply relative importance.

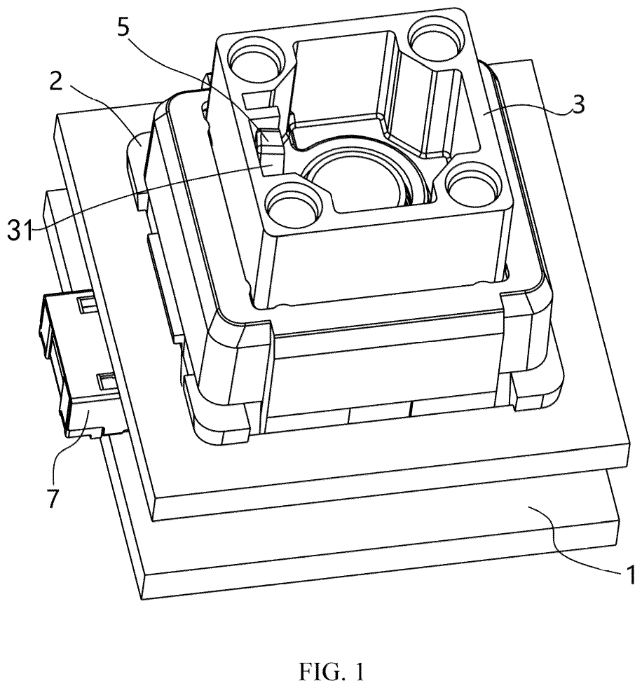

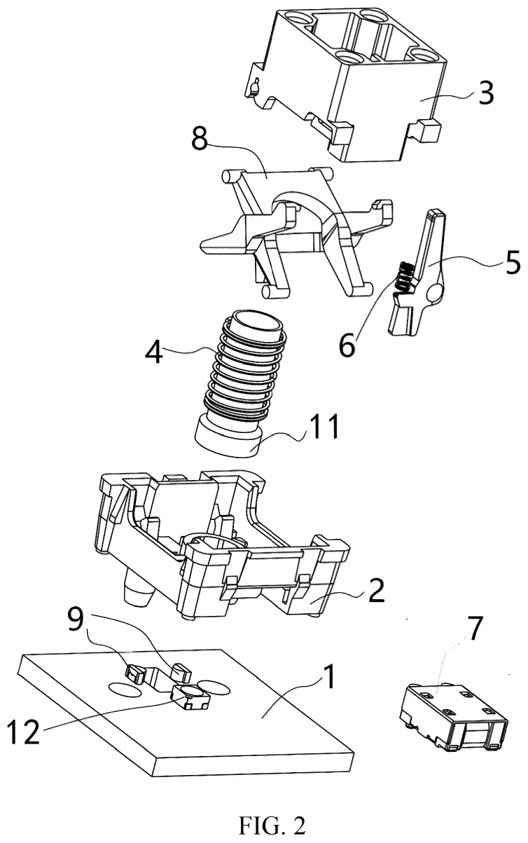

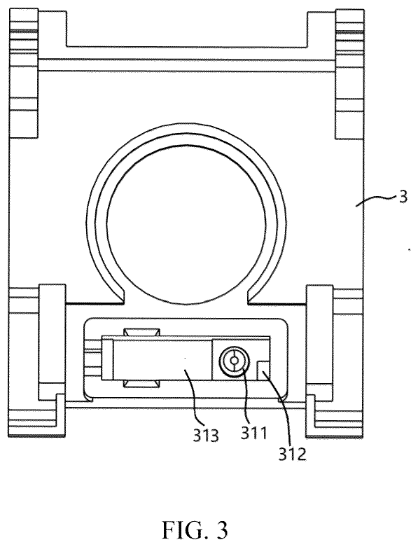

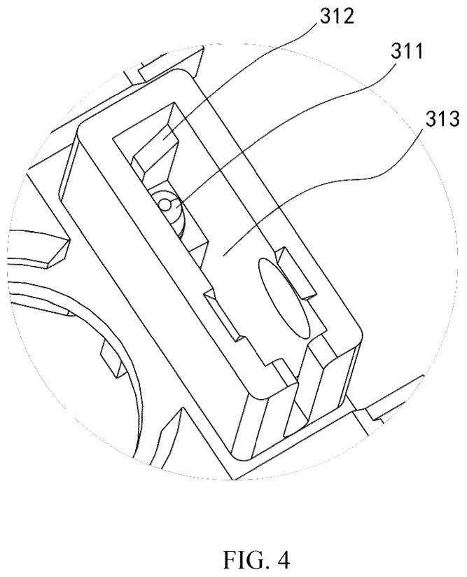

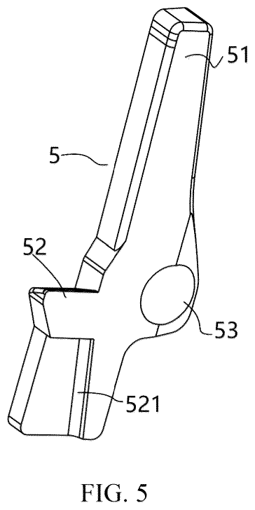

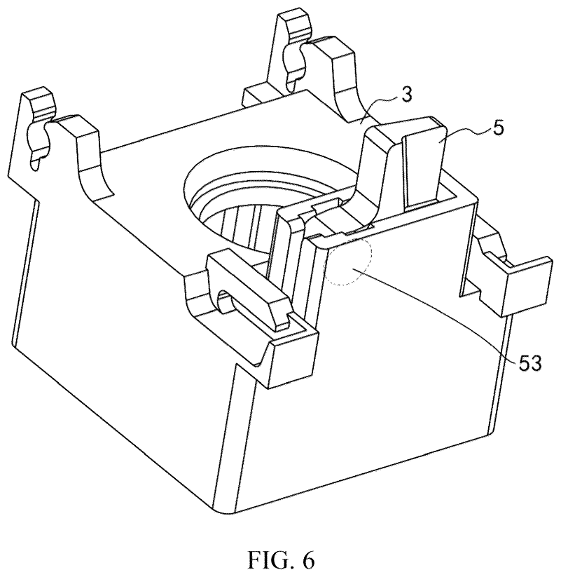

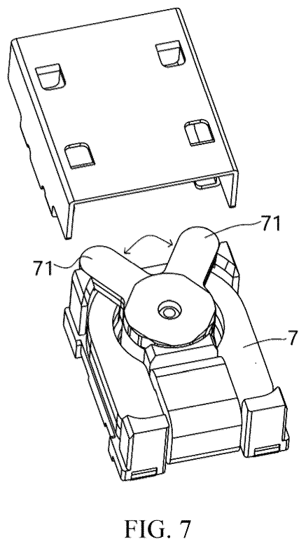

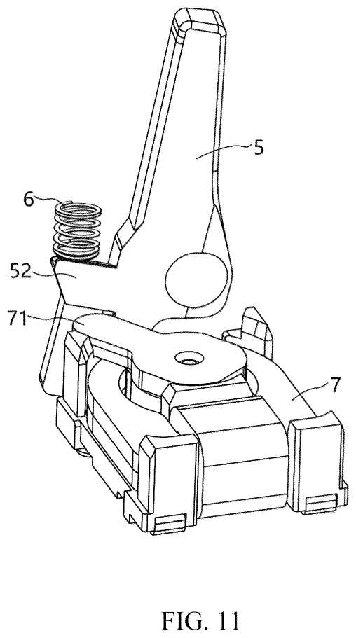

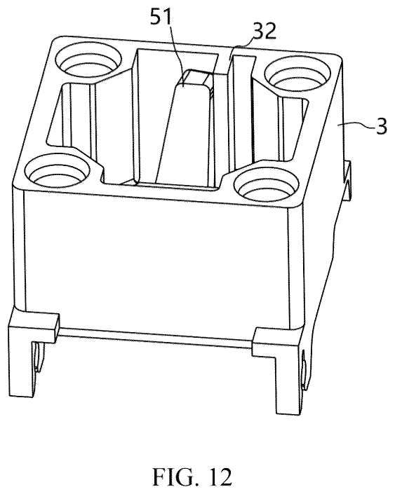

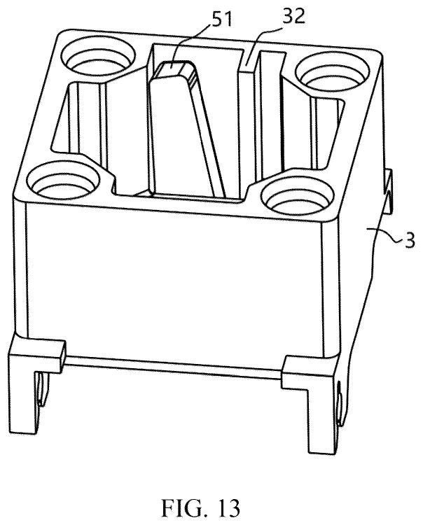

As shown in FIGS. 1-13, a specific embodiment of the present invention relates to a key assembly with switchable sound and silent state, which comprises a key for cooperating with an electrical component 9 on a baseplate 1 to output a signal. Preferably, the baseplate 1 of this key assembly is a PCB board. The key comprises a key base 2 that is assembled on the baseplate 1 and a key shaft 3 that can move up and down in the key base 2. The key shaft 3 has a reset member 4. Preferably, the reset member 4 of this key assembly is a reset spring. A swing arm 5 is pivotally connected to the key shaft 3. The key shaft 3 further has a power-storing member for cooperating with the swing arm 5 to strike the key shaft 3 and make a sound.

To adjust the sound and silent states of the key, this key assembly further comprises an electric switching unit 7, which extends toward a bottom portion of the swing arm 5 to form an electric control swing rod 71. A limit structure 521 is configured at the bottom portion of the swing arm 5. The electric switching unit 7 is electrically connected to the PCB board. The key assembly is further externally connected to a control unit of the electric switching unit 7, so as to adjust the position of the electric control swing rod 71 in the electric switching unit 7.

When sound feedback is required, the electric control swing rod 71 is swung to a position where it can come into contact with the limit structure 521. The electric control swing rod 71 and the power-storing member cooperate with the swing arm 5 to make a keystroke sound when the key shaft 3 is pressed, allowing a user to receive feedback in time and providing better striking experience.

When silent operation is required, the electric control swing arm 5 is swung to a position where it cannot come into contact with the limit structure 521. The swing arm 5 cannot store power to make a sound, leaving a silent state when the key shaft 3 is pressed. The silent operation is very useful for circumstances where noise interference needs to be avoided, e.g., using electronic devices in libraries, conference rooms, or other public places where silence is required, or working at night to avoid keystroke sounds from affecting family's sleep.

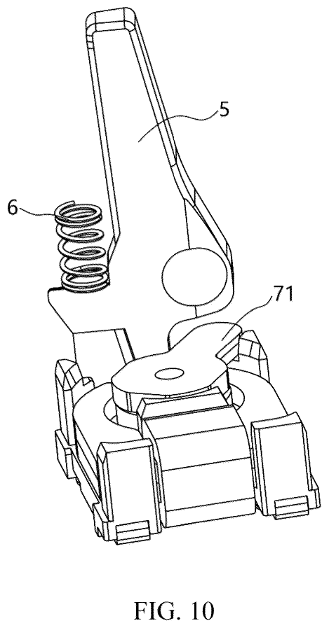

As shown in FIGS. 10-13, the power-storing member of the key assembly comprises a power-storing spring 6 and an inclined table 312 that is configured on the key shaft 3. The swing arm 5 of the key has a middle portion, which is a pivot portion 53. The pivot portion 53 extends on one side to form an abutting table 52. The key shaft 3 has a side wall 32, with an inner side on which a cavity slot 31 is arranged. Both the swing arm 5 and the power-storing member are arranged in the cavity slot 31. The cavity slot 31 has a middle portion that is configured as a pivot cavity 313. The pivot connection between the pivot portion 53 of the swing arm 5 and the key shaft 3 is present in the pivot cavity 313. Preferably, the pivot portion 53 of the swing arm 5 in this key is two protruding circular-arc structures, which are in interference fit with concave slots in the pivot cavity 313, so that the pivot portion 53 can rotate without falling off after snapped into the pivot cavity 31. The power-storing spring 6 has one end that abuts against the abutting table 52, and the other end that is sleeved on a positioning convex column 311 configured on the key shaft 3. Both the inclined table 312 and the positioning convex column 311 are arranged in the pivot cavity 313.

The swing arm 5 of the key has an upper portion, which is a striking portion 51. Preferably, the striking portion 51 of the swing arm 5 and the abutting table 52 form an L-shaped structure, so that the entire swing arm 5 forms a lever structure. The pivot portion 53 is the fulcrum of the lever structure, and the striking portion 51 and the abutting table 52 are arms of force at two ends of the lever structure. When the abutting table 52 swings, the striking portion 51 rotates around the pivot portion 53 and swings.

The specific sound principle of this key assembly is as follows: when the limit structure 521 at the bottom portion of the swing arm 5 descends to come into contact with the electric control swing rod 71 along with the pression on the key shaft 3, it is limited and stopped, and the abutting table 52 squeezes the power-storing spring 6 to store power. At this time, while the pression on the key shaft 3 goes on, the key shaft 3 continues to descend, which makes the inclined table 312 push the limit structure 521 away from the electric control swing rod 71, and further causes the striking portion 51 to swing rapidly and strike the edge wall structure in the key shaft 3 under the tension of the power-storing spring 6, thereby making a keystroke sound.

Wherein, the limit structure 521 at the bottom portion of the swing arm 5 is a structure formed as the abutting table 52 extends downward. In the present application, the limit structure 521 is preferably a slot structure in an obtuse-angled shape.

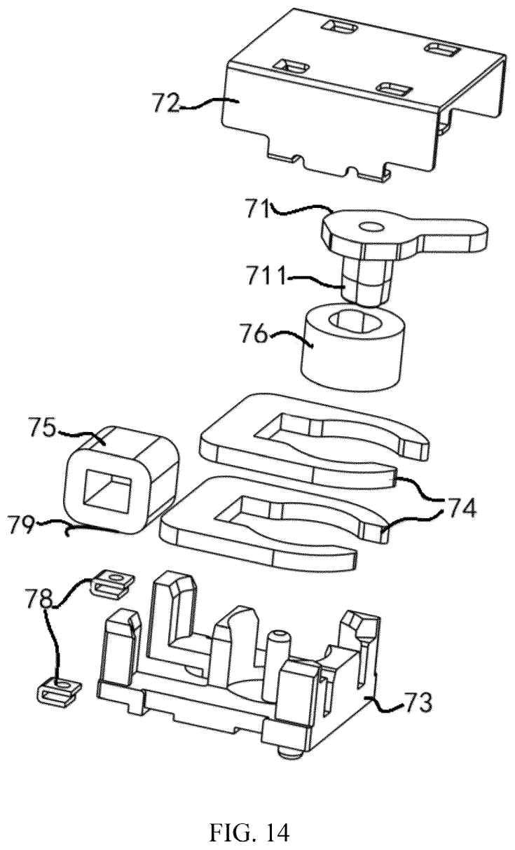

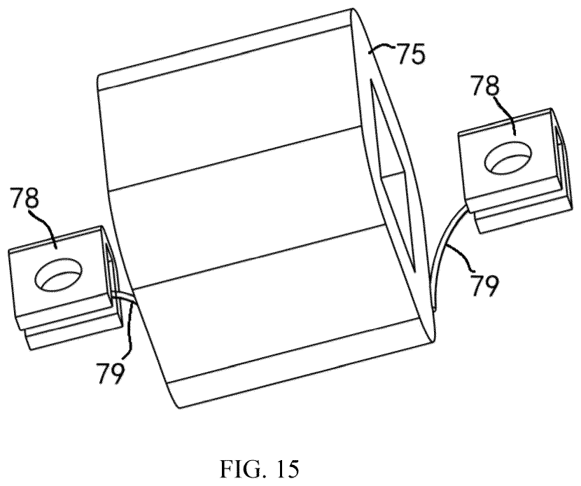

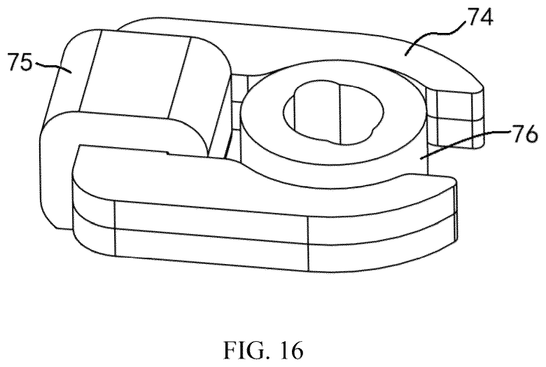

As shown in FIGS. 14-16, the electric switching unit in this key assembly has a housing that consists of an electric control upper cover 72 and an electric control base 73, as well as a magnet 76 and a magnetic conductive plate 74 mounted in the housing. The magnetic conductive plate 74 has one end, on which an electromagnetic coil 75 is sleeved. The electric control swing rod 71 is mounted in the magnet 76. The electromagnetic coil 75 drives the magnet 76 to rotate, thereby making the electric control swing rod 71 rotate together.

To enable the electric switching unit 7 to be connected to the PCB board in a surface-mounted manner, two pins 78 are disposed on both ends of the electric control base 73. Two terminals 79 are arranged on both ends of the electromagnetic coil 75 and electrically connected to the two pins 78, respectively.

A guide column 711 is arranged in the electric control base 73 of the electric switching unit 7. A hollow connecting column 77 is configured on the electric control swing rod 71. The connecting column 77 is sleeved outside the guide column 711 and inserted into a through hole of the magnet 76, which forms an interference fit with the magnet 76, so that when the magnet 76 rotates, the electric control swing rod 71 can rotate along therewith. Preferably, the magnetic conductive plate 74 is a U-shaped structure. Two magnetic conductive plates 74 are arranged side by side in the electric control base 73 and used to reset the magnet 76 in a power-off state, so that the magnet 76 is located in the slot of the magnetic conductive plate 74.

This key assembly further has a light-emitting function. A transparent light guide column 11 is arranged on the baseplate 1. An LED module is arranged at a bottom portion of the transparent light guide column 11. The reset spring is sleeved on the transparent light guide column 11. The transparent light guide column 11 can serve as a positioning column for the reset spring, thereby increasing the stability of the reset spring. At the same time, it allows light of the LED module to diverge from the transparent light guide column 11, thereby providing good key feedback.

Preferably, the key of the present application uses a balance frame 8 and a reset spring as a reset tool. An X-shaped balance frame 8 is arranged between the key shaft 3 and the key base 2. The balance frame 8 is formed as a male frame is pivotally connected to a female frame, and mounted between the key shaft 3 and the key base 2, so as to provide good stability and balance of the key, avoid the key from tilting or shaking during use, and improve the reliability of the key. In addition, an inductive portion 81 that can change electrical signals of the electrical component 9 is further arranged on one end of the balance frame 8 (male or female frame).

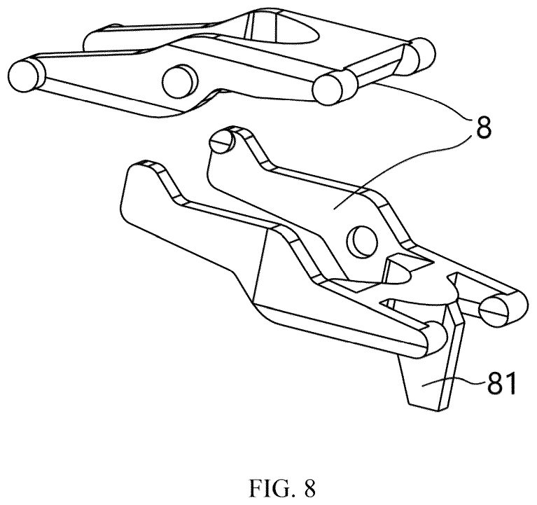

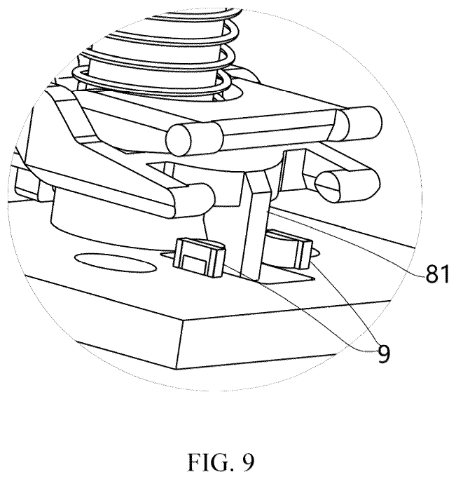

As shown in FIGS. 8-9, when the inductive portion 81 is a grating member, the electrical component 9 is a light pair transistor assembly that consists of a light-emitting component and a light-receiving component. The light pair transistor assembly is arranged at a position adjacent to a grating to form an optical path. When the key shaft 3 is pressed, the grating member gradually changes the optical path between the light-emitting component and the light-receiving component along with the descent of the balance frame 8, thereby gradually changing the luminous flux received by the light-receiving component and forming an optical variable signal.

When the inductive portion 81 is a magnetic member, the electrical component 9 is a Hall sensor. When the key shaft 3 is pressed, the magnetic member gradually changes the magnetic flux received by the Hall sensor along with the descent of the balance frame 8, thereby gradually changing the magnetic flux received by the Hall sensor and forming an electromagnetic signal.

The above description only relates to preferred embodiments of the present invention, and is not intended to limit the present invention. Any minor modifications, equivalent substitutions, and improvements made to the above embodiments based on the technical essence of the present invention should fall within the scope of protection of the technical solution of the present invention.

1: A key assembly with switchable sound and silent states, comprising a key for cooperating with an electrical component on a baseplate to output a signal, wherein the key comprises a key base that is assembled on the baseplate and a key shaft that can move up and down in the key base, and the key shaft has a reset member, characterized in that a swing arm is pivotally connected to the key shaft, which further has a power-storing member for cooperating with the swing arm to strike the key shaft and make a sound; the key assembly further comprises an electric switching unit, which extends toward a bottom portion of the swing arm to form an electric control swing rod, and a limit structure is arranged at the bottom portion of the swing arm; when the electric control swing rod swings to a position where it can come into contact with the limit structure, the electric control swing rod and the power-storing member cooperate with the swing arm to make a keystroke sound when the key shaft is pressed; when the electric control swing arm swings to a position where it cannot come into contact with the limit structure, the swing arm cannot store power to make a sound, leaving a silent state when the key shaft is pressed.

2: The key assembly with switchable sound and silent states according to claim 1, characterized in that the power-storing member comprises a power-storing spring and an inclined table that is configured on the key shaft; the swing arm has a middle portion as a pivot portion and an upper portion as a striking portion, the pivot portion has one side that extends to form an abutting table, and the power-storing spring has one end that abuts against the abutting table and the other end that is sleeved on a positioning convex column configured on the key shaft; when the limit structure at the bottom portion of the swing arm descends along with the pression on the key shaft and comes into contact with the electric control swing rod, it is limited and stopped, and further squeezes the power-storing spring to store power, and the key shaft continues to descend, which makes the inclined table push the limit structure away from the electric control swing rod, and further causes the striking portion to swing rapidly and strike the key shaft under the tension of the power-storing spring, thereby making a keystroke sound.

3: The key assembly with switchable sound and silent states according to claim 2, characterized in that the limit structure at the bottom portion of the swing arm is a structure that extends downward from the abutting table.

4: The key assembly with switchable sound and silent states according to claim 2, characterized in that a cavity slot is configured on an inner side of a side wall of the key shaft, both the swing arm and the power-storing member are arranged in the cavity slot, the cavity slot has a middle portion that is configured as a pivot cavity, the pivot connection between the pivot portion of the swing arm and the key shaft is present in the pivot cavity, and both the inclined table and the positioning convex column are arranged in the pivot cavity.

5: The key assembly with switchable sound and silent states according to claim 2, characterized in that the electric switching unit comprises a housing that consists of an electric control upper cover and an electric control base, as well as a magnet and a magnetic conductive plate mounted in the housing, the magnetic conductive plate has one end, on which a electromagnetic coil is sleeved, the electric control swing rod is mounted in the magnet, and the electromagnetic coil drives the magnet to rotate, thereby making the electric control swing rod rotate together;
the electric control base has two ends that are provided with two pins, and two terminals are arranged on both ends of the electromagnetic coil and electrically connected to the two pins, respectively.

6: The key assembly with switchable sound and silent states according to claim 5, characterized in that a guide column is arranged in the electric control base, a hollow connecting column is configured on the electric control swing rod, and the connecting column is sleeved outside the guide column and inserted into a through hole of the magnet.

7. (canceled)

8: The key assembly with switchable sound and silent states according to claim 6, characterized in that an X-shaped balance frame is arranged between the key shaft and the key base, the balance frame is mounted between the key shaft and the key base, and on one end, the balance frame is provided with an inductive portion that can change electrical signals of the electrical component.

9: The key assembly with switchable sound and silent states according to claim 8, characterized in that the inductive portion is a grating member, the electrical component is a light pair transistor assembly that consists of a light-emitting component and a light-receiving component, and the light pair transistor assembly is arranged at a position adjacent to a grating to form an optical path, the grating member gradually changes the optical path between the light-emitting component and the light-receiving component along with the descent of the balance frame when the key shaft is pressed, thereby gradually changing luminous flux received by the light-receiving component and forming an optical variable signal.

10: The key assembly with switchable sound and silent states according to claim 8, characterized in that the inductive portion is a magnetic member, the electrical component is a Hall sensor, and the magnetic member gradually changes magnetic flux received by the Hall sensor along with the descent of the balance frame when the key shaft is pressed, thereby gradually changing the magnetic flux received by the Hall sensor and forming an electromagnetic signal.
